(19) United States
(12) Patent Application Publication
(10) Pub. No.: US 2017/0048144 A1
(43) Pub. Date: Feb. 16, 2017

(54) Congestion Avoidance Traffic Steering (CATS) in Datacenter Networks

(71) Applicant: Futurewei Technologies, Inc., Plano, TX (US)

(72) Inventor: Fangping Liu, San Jose, CA (US)

(21) Appl. No.: 14/825,913

(22) Filed: Aug. 13, 2015

(51) Int. Cl. H04L 12/803; H04L 12/935; H04L 12/851; H04L 12/707; H04L 12/743; H04L 29/06

(52) U.S. Cl. CPC H04L 47/122; H04L 45/7453; H04L 69/22; H04L 47/2441; H04L 45/24; H04L 49/3027

(57) ABSTRACT

A network element (NE) comprising an ingress port configured to receive a first packet via a multipath network, a plurality of egress ports configured to couple to a plurality of links in the multipath network, and a processor coupled to the ingress port and the plurality of egress ports, wherein the processor is configured to determine that the plurality of egress ports are candidate egress ports for forwarding the first packet, obtain dynamic traffic load information associated with the candidate egress ports, and select a first target egress port from the candidate egress ports for forwarding the first packet according to the dynamic traffic load information.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Network congestion occurs when demand for a resource exceeds the capacity of the resource. In an Ethernet network, when congestion occurs, traffic passing through a congestion point slows down significantly, either through packet drop, congestion notification, or back pressure mechanisms. Some examples of packet drop mechanisms may include tail drop (ID), random early detection (RED), and weighted RED (WIRED). A TD scheme drops packets at the tail end of a queue when the queue is full. A RED scheme monitors an average packet queue size and drops packets based on statistical probabilities. A WRED scheme drops lower priority packets before dropping higher priority packets. Some examples of congestion notification algorithms may include explicit congestion notification (ECN) and quantized congestion control (QCN), where notification messages are sent to cause traffic sources to respond to congestion by adjusting transmission rate. Back pressure employs flow control signaling mechanisms, where congestion states are signaled to upstream hops to delay and/or suspend transmissions of additional packets, where upstream hops refer to network nodes in a direction towards a packet source.

### SUMMARY

In one embodiment, the disclosure includes a network element (NE) comprising an ingress port configured to receive a first packet via a multipath network, a plurality of egress ports configured to couple to a plurality of links in the multipath network, and a processor coupled to the ingress port and the plurality of egress ports, wherein the processor is configured to determine that the plurality of egress ports are candidate egress ports for forwarding the first packet, obtain dynamic traffic load information associated with the candidate egress ports, and select a first target egress port from the candidate egress ports for forwarding the first packet according to the dynamic traffic load information.

In another embodiment, the disclosure includes an NE, comprising an ingress port configured to receive a plurality of packets via a multipath network, a plurality of egress ports configured to forward the plurality of packets over a plurality of links in the multipath network, a memory coupled to the ingress port and the plurality of egress ports, wherein the memory is configured to store a plurality of egress queues, and wherein a first of the plurality of egress queues stores packets awaiting transmissions over a first of the plurality of links coupled to a first of the plurality of egress ports, and a processor coupled to the memory and configured to send a congestion-on notification to a path selection element when determining that a utilization level of the first egress queue is greater than a congestion-on threshold, wherein the congestion-on notification instructs the path selection element to stop selecting the first egress port for forwarding first subsequent packets.

In yet another embodiment, the disclosure includes a method implemented in an NE, the method comprising receiving a packet via a datacenter network, identifying a plurality of NE egress ports for forwarding the received packet over a plurality of redundant links in the datacenter network, obtaining transient congestion information associated with the plurality of NE egress ports, and selecting a target NE egress port from the plurality of NE egress ports for forwarding the received packet according to the transient congestion.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a multipath network system.

FIG. 2 is a schematic diagram of an embodiment of an equal-cost multipath (ECMP)-based network switch.

FIG. 3 is a schematic diagram of an embodiment of a congestion avoidance traffic steering (CATS)-based network switch.

FIG. 4 is a schematic diagram of an embodiment of a network element (NE) acting as a node in a multipath network.

FIG. 5 illustrates an embodiment of a congestion scenario at an ECMP-base network switch.

FIG. 6A illustrates an embodiment of a congestion detection scenario at a CATS-based network switch.

FIG. 6B illustrates an embodiment of a congestion isolation and traffic diversion scenario at a CATS-based network switch.

FIG. 6C illustrates an embodiment of a congestion clear scenario at a CATS-based network switch.

FIG. 7 is a schematic diagram of a flowlet table.

FIG. 8 is a schematic diagram of a port queue congestion table.

FIG. 9 is a schematic diagram of an egress queue state machine.

FIG. 10 is a flowchart of an embodiment of a CATS method.

FIG. 11 is a flowchart of another embodiment of a CATS method.

FIG. 12 is a flowchart of an embodiment of a congestion event handling method.

FIG. 13 is a graph illustrating an example egress traffic class queue usage over time.

FIG. 14 is a timing diagram illustrating an embodiment of a CATS congestion handling scenario.

FIG. 15 is a graph of example datacenter bisection bandwidth utilization.

FIG. 16 is a graph of example datacenter link utilization cumulative distribution function (CDF).

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalent.

Multipath routing allows the establishment of multiple paths between a source-destination pair. Multipath routing provides a variety of benefits, such as fault tolerance and increased bandwidth. For example, when an active or default path for a traffic flow fails, the traffic flow may be routed to an alternate path. Load balancing may also be performed to distribute traffic load among the multiple paths. Packet-based load balancing may not be practical due to packet reordering, and thus may be rarely deployed. However, flow-based load balancing may be more beneficial. For example, datacenters may be designed with redundant links (e.g., multiple paths) and may employ flow-based load balancing algorithms to distribute load over the redundant links. An example flow-based load balancing algorithm is the ECMP-based load balancing algorithm. The ECMP-based load balancing algorithm balances multiple flows over multiple paths by hashing traffic flows (e.g., flow-related packet header fields) onto multiple best paths. However, datacenter traffic may be random and traffic bursts may occur sporadically. Traffic burst refers to a high volume of traffic that occurs over a short duration of time. Thus, traffic bursts may lead to congestion points in datacenters. The employment of an ECMP-based load balancing algorithm may not necessarily steer traffic away from the congested link since the ECMP-based load balancing algorithm does not consider traffic load and/or congestion during path selection. Some studies on datacenter traffic indicate that at any given short time interval, about 40 percent (%) of datacenter links does not carry any traffic. As such, utilization of the redundant links provisioned by datacenters may not be efficient.

Disclosed herein are various embodiments for performing congestion avoidance traffic steering (CATS) in a network, such as a datacenter network, configured with redundant links. The disclosed embodiments enable network switches, such as Ethernet switches, to detect traffic bursts and/or potential congestion and to redirect subsequent traffic in real time to avoid congested links. In an embodiment, a network switch comprises a plurality of ingress ports, a packet processor, a traffic manager, and a plurality of egress ports. The ingress ports and the egress ports are coupled to physical links in the network, where at least some of the physical links are redundant links suitable for multipath routing. The network switch receives packets via the ingress ports. The packet processor classifies the received packets into traffic flows and traffic classes. Traffic class refers to the differentiation of different network traffic types (e.g., data, audio, and video), where transmission priorities may be configured based on the network traffic types. For example, each packet may be sent via a subset of the egress ports (e.g., candidates) corresponding to the redundant links available for each traffic flow. The packet processor selects an egress port and a corresponding path for each packet by applying a hash function to a set of the packet header fields associated with the classified traffic flow. After selecting an egress port for the packet, the packet may be enqueued into a transmission queue for transmission to the selected egress port. For example, each transmission queue may correspond to an egress port. The traffic manager monitors utilization levels of the transmission queues associated with the egress ports and notifies the packet processor of egress port congestion states, for example, based on transmission queue thresholds. In an embodiment, the traffic manager may employ different transmission queue thresholds for different traffic classes to provide different quality of service (QoS) to different traffic classes. As such, a particular egress ports may comprise different congestions states for different traffic classes. To avoid congestion, the packet processor excludes the congested candidate egress ports indicated by the traffic manager from path selection, and thus traffic is steered to alternate paths and congestion is avoided. When a congested egress port transitions to a congestion-off state, the packet processor may include the egress port during a next path selection, and thus traffic may be resumed on a congested path that is subsequently free of congestion. In some embodiments, the packet processor and the traffic manager are implemented as application specific integrated circuits (ASICs), which may be fabricated on a same semiconductor die or on different semiconductor dies. The disclosed embodiments may operate with any network software stacks, such as existing transmission control protocol (TCP) and/or Internet protocol (IP) software stacks. The disclosed embodiments may be suitable for use with other congestion control mechanisms, such as ECN, pricing for congestion control (PFCC), RED, and TD. It should be noted that in the present disclosure, path selection and port selection are equivalent and may be employed interchangeably.

In contrast to the ECMP algorithm, the disclosed embodiments are aware of traffic load and/or congestion state of each transmission queue on each egress port, whereas the ECMP algorithm is load agnostic. Thus, the disclosed embodiments may direct traffic to uncongested redundant links that are otherwise under-utilized. In contrast to the packet-drop congestion control method, the disclosed embodiments steer traffic away from potentially congested links to redundant links instead of dropping packets as in the packet-drop congestion control method. The packet-drop congestion control method may relieve congestion, but may not utilize redundant links during congestion. In contrast to the backpressure congestion control method, the disclosed embodiments steer traffic away from potentially congested links instead of requesting packet sources to reduce transmission rates as in the backpressure congestion control method. The backpressure congestion method may relieve congestion, but may not utilize redundant links during congestion. In contrast to distribute congestion-aware load balancing (CONGA), the disclosed embodiment respond to congestion in an order of a few microseconds (μs), where traffic is steered away from potentially congested links to redundant links to avoid traffic discards that are caused by traffic bursts. The CONGA method monitors link utilization and may achieve good load balance. However, the CONGA method is not burst aware, and thus may not avoid traffic discards resulted from traffic bursts. In addition, the CONGA method responds to a link utilization change in an order of a few hundred μs. In addition, the disclosed embodiments may be applied to any datacenters, whereas CONGA is limited to small datacenters with tunnel fabrics.

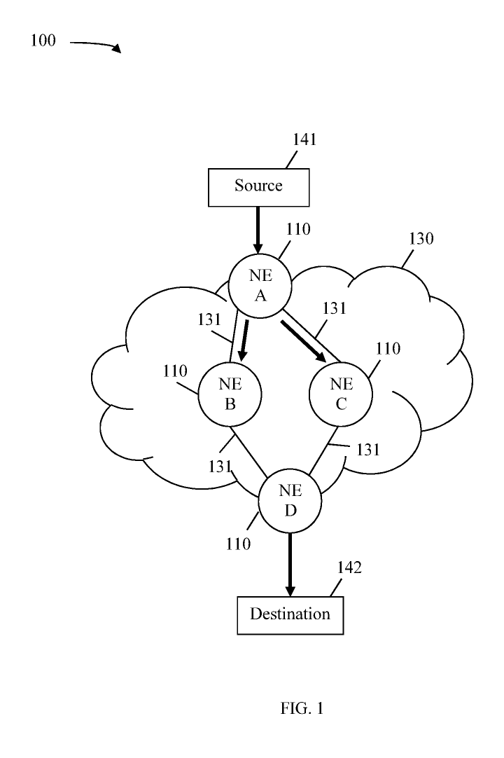

FIG. 1 is a schematic diagram of an embodiment of a multipath network system 100. The system 100 comprises a network 130 that connects a source 141 to a destination 142. The source 141 may be any device configured to generate data. The destination 142 may be any device configured to consume data. The network 130 may be any types of network, such as an electrical network and/or an optical network. The network 130 may operate under a single network administrative domain or multiple network administrative domains. The network 130 may employ any network communication protocols, such as TCP/IP. The network 130 may further employ any types of network virtualization and/or network overlay technologies, such as a virtual extensible local area network (VXLAN). The network 130 is configured to provide multiple paths (e.g., redundant links) for routing data flows in the network 130. As shown, the network 130 comprises a plurality of NEs 110 (e.g., NE A, NE B, NE C, and NE D) interconnected by a plurality of links 131, which are physical connections. The links 131 may comprise electrical links and/or optical links. The NEs 110 may be any devices, such as routers, switches, and/or bridges, configured to forward data in the network 130. A traffic flow (e.g., data packets) from the source 141 may enter the network 130 via the NE A 110 and reaches the destination 142 via the NE D 110. Upon receiving the data packets from the traffic flow, the NE A 110 may select a next hop and/or a forwarding path for the received packets. As shown, the network 130 provides multiple paths for the NE A 110 to forward the received data packet towards the destination 142. For example, the NE A 110 may decide to forward certain data packets to the NE B 110 and some other data packets to the NE C 110. In order to determine whether to select the NE B 110 or the NE C 110 as the next hop, the NE A 110 may employ a hashing mechanism, in which a hash function may be applied to a set of packet header fields to determine a hash value and a next hop may be selected based on the hash value. In an embodiment, the network 130 may be a datacenter network and the NEs 110 may be access layer switches, aggregation layer switches, and/or core layer switches. It should be noted that the network system 100 may be configured as shown or alternatively configured as determined by a person of ordinary skill in the art to achieve similar functionalities.

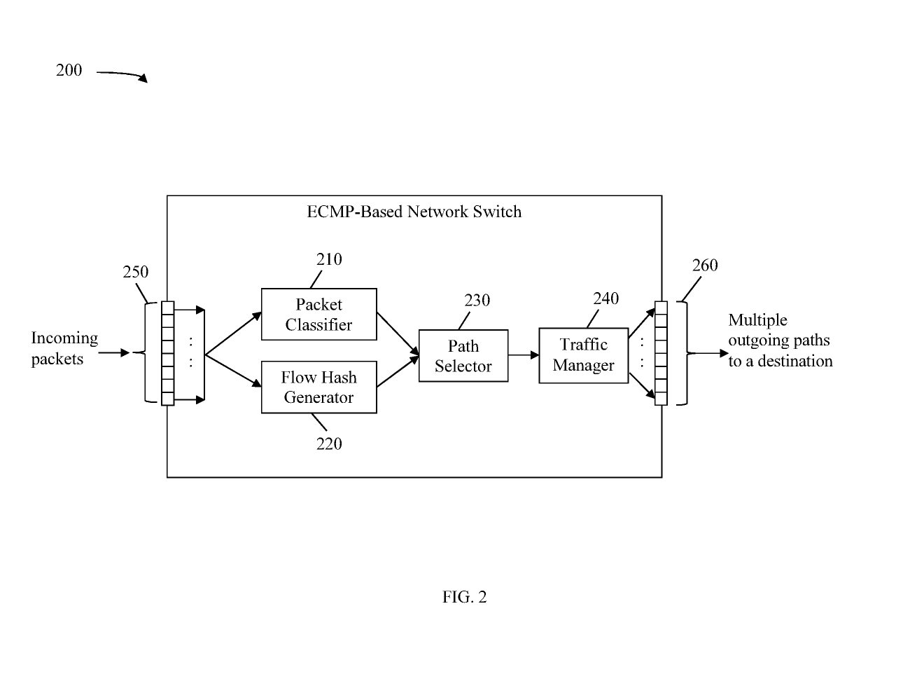

FIG. 2 is a schematic diagram of an embodiment of an ECMP-based network switch 200. The network switch 200 may act as an NE, such as the NEs 110, in a multipath network, such as the network 130. The network switch 200 implements an ECMP algorithm for routing and load balancing. The network switch 200 comprises a packet classifier 210, a flow hash generator 220, a path selector 230, a traffic manager 240, a plurality of ingress ports 250, and a plurality of egress ports 260. The packet classifier 210, the flow hash generator 220, the path selector 230, and the traffic manager 240 are functional modules, which may comprise hardware and/or software. The ingress ports 250 and the egress ports 260 may comprise hardware components and/or logics and may be configured to couple to network links, such as the links 131. The network switch 200 receives incoming data packets via the ingress ports 250, for example, from one or more NEs such as the NEs 110, and routes the data packets to the egress ports 260 according to the ECMP algorithm, as discussed more fully below.

The packet classifier 210 is configured to classify incoming data packets into traffic flows. For example, packet classification may be performed based on packet headers, which may include Open System Interconnection (OSI) Layer 2 (L2), Layer 3 (L3), and/or Layer 4 (L4) headers. The flow hash generator 220 is configured to compute hash values based on traffic flows. For example, for each packet, the flow hash generator 220 may apply a hash function to a set of packet header fields that defines the traffic flow to produce a hash value. The path selector 230 is configured to select a subset of the egress ports 260 (e.g., candidate ports) for each packet based on the classified traffic flow and select an egress port 260 from the subset of the egress ports 260 based on the computed hash value. For example, the hash function produces a range of hash values and each egress port 260 is mapped to a portion of the hash value range. Thus, egress port 260 that is mapped to a portion corresponding to the computed hash value is selected. After selecting an egress port 260, the path selector 230 enqueues the data packet into an egress queue corresponding to the packet traffic class and associated with the selected egress port 260 for transmission over the link coupled to the selected egress port 260. The traffic manager 240 is configured to manage the egress queues and the transmissions of the packets. The hashing mechanisms may potentially spread traffic load of multiple flows over multiple paths. However, the path selector 230 is unaware of traffic load. Thus, when a traffic burst occurs, the hashing mechanisms may not distribute subsequent traffic to alternate paths.

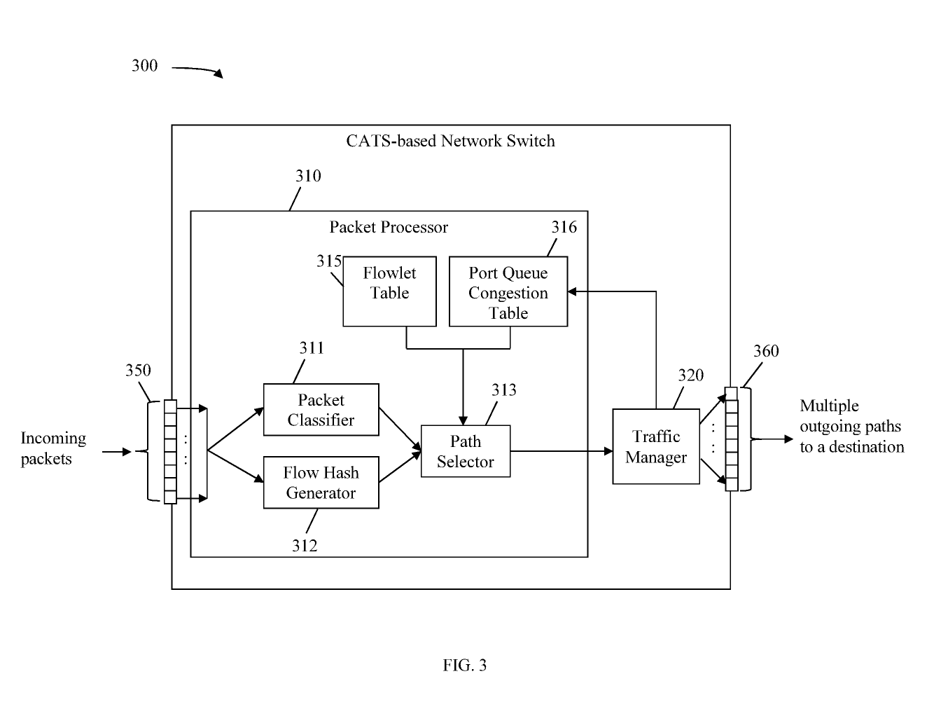

FIG. 3 is a schematic diagram of an embodiment of a CATS-based network switch 300. The network switch 300 may act as an NE, such as the NEs 110, in a multipath network, such as the network 130. The network switch 300 implements a CATS scheme, in which path selection is aware of traffic load (e.g., occurrences of traffic bursts). Thus, the network switch 300 may steer subsequent traffic away from potential congested links, such as the links 131. The network switch 300 comprises a packet processor 310, a traffic manager 320, a plurality of ingress ports 350, and a plurality of egress ports 360. The ingress ports 350 and the egress ports 360 are similar to the ingress ports 250 and the egress ports 260, respectively. In an embodiment, the packet processor 310 and the traffic manager 320 are hardware units, which may be implemented as a single ASIC or separate ASICs. The network switch 300 comprises a packet classifier 311, a flow hash generator 312, a path selector 313, a flowlet table 315, and a port queue congestion table 316. The network switch 300 receives incoming data packets via the ingress ports 350, for example, from one or more NEs such as the NEs 110. The incoming packets may be queued in ingress queues, for example, stored in memory at the network switch 300.

The packet classifier 311 is configured to classify the incoming packets into traffic flows and/or traffic classes, for example, based on packet header fields, such as media access control (MAC) source address, MAC destination address, IP source address, IP destination address, Ethernet packet type, transport port, transport protocol, transport source address, and/or transport destination address. In some embodiments, packet classification may additionally be determined based on other rules, such as pre-established policies. Packet traffic class may be determined by employing various mechanisms, for example, through packet header fields, pre-established policies, and/or derived from ingress port 350 attributes. After a packet is successfully classified, a list of candidate egress ports 360 is generated for egress transmission. The flow hash generator 312 is configured to compute a hash value for each incoming packet by applying a hash function to a set of the flow-related packet header fields. The list of candidate egress ports 360, the flow hash value, the packet headers, and other packet attributes are passed along to subsequent processing stages including the path selector 313.

The flowlet table 315 stores flowlet entries. In some embodiment, traffic flows determined from the packet classifier 311 may be aggregated flows comprising a plurality of micro-flows, which may comprise more specific matching keys compared with the associated aggregated traffic flows. A flowlet is a portion of a traffic, where the portion spans a short time duration. Thus, flowlets may comprise short aging periods and may be periodically refreshed and/or aged. An entry in the flowlet table 315 may comprise an n-tuple match key, an outgoing interface, and/or maintenance information. The n-tuple match key may comprise match rules for a set of packet header fields that defines a traffic flow. The outgoing interface may comprise an egress ports 360 (e.g., one of the candidate ports) that may be employed to forward packets associated with the traffic flow identified by the n-tuple match key. The maintenance information may comprise aging and/or timing information associated with the flowlet identified by the n-tuple match key. The flowlet table 315 may be pre-configured and updated as new traffic flowlets are identified and/or existing traffic flows are aged.

The port queue congestion table 316 stores congestion statuses or states of transmission queues of the egress ports 360. For example, the network switch 300 may enqueue packets by egress port 360 and traffic class, where each egress port 360 is associated with a plurality of transmission queues of different traffic classes. The congestion states are determined by the traffic manager 320 based on egress queue thresholds, as discussed more fully below. In an embodiment, a link may be employed for transporting multiple traffic flows of different traffic classes, which may guarantee different QoS. Thus, an entry in a port queue congestion table 316 may comprise a plurality of bits (e.g., about 8 bits), each indicating a congestion state for a particular traffic class at an egress port 360.

The path selector 313 is configured to select an egress port 360 for each incoming data packet. The path selector 313 searches the flowlet table 315 for an entry that matches key fields including packet header fields and traffic class of the incoming data packet. When a match is found in the flowlet table 315, the path selector 313 obtains the egress port 360 from the matched flowlet entry and looks up the port queue congestion table 316 to determine whether the transmission queue for the packet traffic class on the egress ports 360 is congested. If the packet traffic class queue on the egress port 360 is not congested, the port from the matching flowlet entry is used for packet transmission. If the packet traffic class queue on the egress port 360 is congested, the path selector 313 chooses a different egress port 360 for transmission. The path selector 313 excludes any congested egress ports 360 during path selection. To choose a different egress port 360, the path selector 313 goes through the list of candidate egress ports 360 determined from the packet classifier 311. For example, for each candidate egress port 360, if the queue for the packet traffic class on the egress port 360 is congested, the egress port 360 is excluded from path selection. The remaining egress ports 360 may be used for port selection based on the flow hash. In an embodiment, the key space of the hash value is divided among the candidate egress ports 360 and each candidate egress port 360 may be mapped to a region of the key space. As an example, the hash value may be 4-bit value between 0 to 15 and the number of candidate egress ports 360 may be four. When splitting the key space equally, each egress port 360 may be mapped to four hash values. However, when one of the candidate egress ports 360 is congested, the path selector 313 excludes the congested candidate egress port 360 and divides the key space among the remaining three candidate egress ports 360. When a match for an incoming packet is not found in the flowlet table 315, the path selector 313 selects an egress port 360 by hashing among the non-congested egress ports 360 and adds an entry to the flowlet table 315. For example, the entry may comprise an n-tuple match key that identifies a traffic flow and/or a traffic class of the incoming packet and the selected egress port 360.

The traffic manager 320 is configured to manage transmissions of packets over the egress ports 360. The traffic manager 320 monitors for congestion states of the egress ports 360 and notifies the packet processor 310 of the egress ports 360's congestion states to enable the packet selector 313 to perform congestion-aware path selection as described above. For example, the packet processor 310 may employ a separate egress queue (e.g., stored in memory) to queue packets for each egress port 360. Thus, the traffic manager 320 may determine congestion states based on the number of packets in the egress queues pending for transmission (e.g., queue utilization levels). In an embodiment, the traffic manager 320 may employ two thresholds, a congestion-on threshold and a congestion-off threshold. The congestion-on threshold and the congestion-off threshold are measured in terms of number of packets in an egress queue. When an egress queue for a particular egress port 360 reaches the congestion-on threshold, the traffic manager 320 may set the congestion state for the particular egress port 360 to congestion-on. When an egress queue for a particular egress port 360 falls below the congestion-off threshold, the traffic manager 320 may set the congestion state for the particular egress port 360 to congestion-off. In some embodiments, the traffic manager 320 may employ different congestion-on and congestion-off thresholds for traffic flows with different traffic classes so that a particular QoS may be guaranteed for a particular traffic class. Thus, for a particular egress port 360, the traffic manager 320 may set different congestion states for different traffic classes. For example, when the network switch 300 supports eight different traffic classes, the traffic manager 320 may indicate eight congestion states for each egress port 360, where each congestion state correspond to one of the traffic classes. It should be noted that the network switch 300 may be configured as shown or alternatively configured as determined by a person of ordinary skill in the art to achieve similar functionalities.

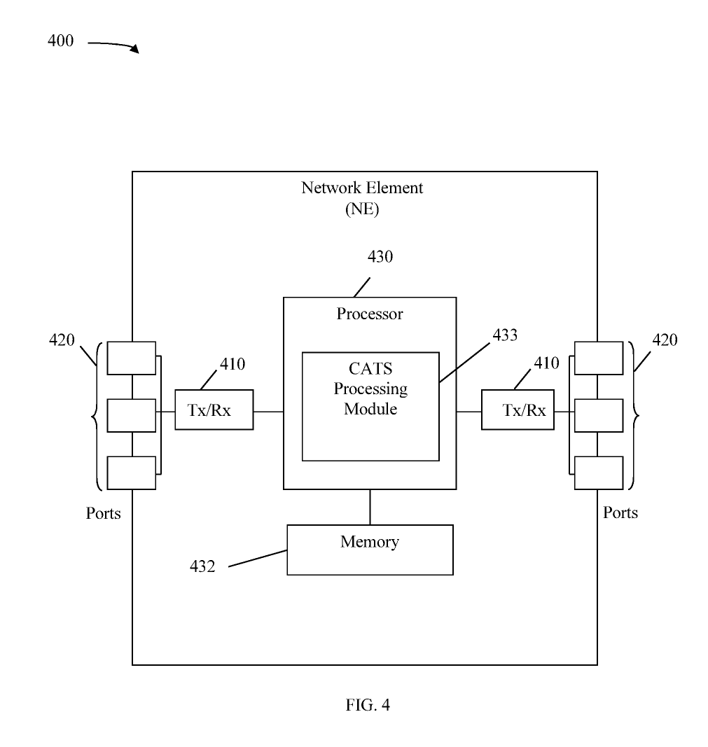

FIG. 4 is a schematic diagram of an example embodiment of an NE 400 acting as a node, such as the NEs 110 and the network switches 200 and 300 in a multipath network, such as the network 130. NE 400 may be configured to implement and/or support the CATS mechanisms described herein. NE 400 may be implemented in a single node or the functionality of NE 400 may be implemented in a plurality of nodes. One skilled in the art will recognize that the term NE encompasses a broad range of devices of which NE 400 is merely an example. NE 400 is included for purposes of clarity of discussion, but is in no way meant to limit the application of the present disclosure to a particular NE embodiment or class of NE embodiments. At least some of the features and/or methods described in the disclosure may be implemented in a network apparatus or module such as an NE 400. For instance, the features and/or methods in the disclosure may be implemented using hardware, firmware, and/or software installed to run on hardware. As shown in FIG. 4, the NE 400 may comprise transceivers (Tx/Rx) 410, which may be transmitters, receivers, or combinations thereof A Tx/Rx 410 may be coupled to plurality of ports 420, such as the ingress ports 250 and 350 and the egress ports 260 and 360, for transmitting and/or receiving frames from other nodes and a Tx/Rx 410. The processor 430 may comprise one or more multi-core processors and/or memory devices 432, which may function as data stores, buffers, etc. The processor 430 may be implemented as a general processor or may be part of one or more ASICs and/or digital signal processors (DSPs). The processor 430 may comprise a CATS processing module 433, which may perform processing functions of a network switch and implement methods 1000, 1100, and 1200, and state machine 900, as discussed more fully below, and/or any other method discussed herein. As such, the inclusion of the CATS processing module 433 and associated methods and systems provide improvements to the functionality of the NE 400. Further, the CATS processing module 433 effects a transformation of a particular article (e.g., the network) to a different state. In an alternative embodiment, the CATS processing module 433 may be implemented as instructions stored in the memory devices 432, which may be executed by the processor 430. The memory device 432 may comprise a cache for temporarily storing content, e.g., a random-access memory (RAM). Additionally, the memory device 432 may comprise a long-term storage for storing content relatively longer, e.g., a read-only memory (ROM). For instance, the cache and the long-term storage may include dynamic RAMs (DRAMs), solid-state drives (SSDs), hard disks, or combinations thereof. The memory device 432 may be configured to store a flowlet table, such as the flowlet table 315, a port queue congestion table, such as the port queue congestion table 316, and/or transmission queues.

It is understood that by programming and/or loading executable instructions onto the NE 400, at least one of the processor 430 and/or memory device 432 are changed, transforming the NE 400 in part into a particular machine or apparatus, e.g., a multi-core forwarding architecture, having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

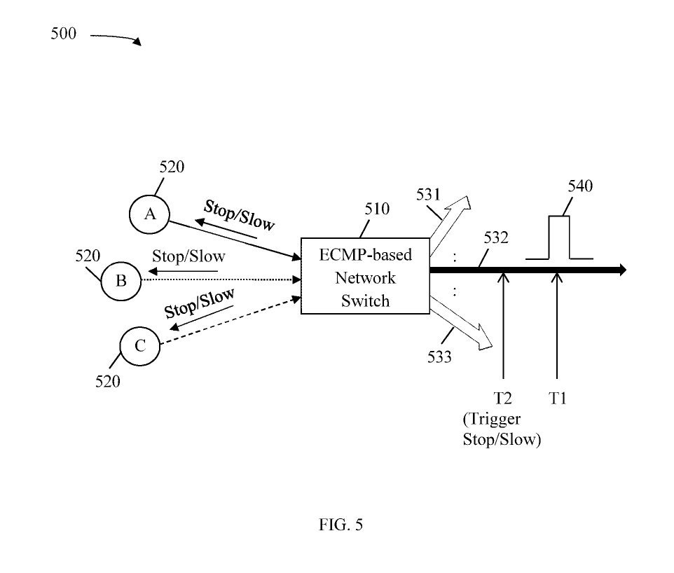

FIG. 5 illustrates an embodiment of a congestion scenario 500 at an ECMP-based network switch 510. The network switch 510 is similar to the network switch 200. As an example, the network switch 510 is configured with a plurality of redundant links 531, 532, and 533, such as the links 131, for forwarding packets received from a plurality of sources A, B, and C 520, such as the source 141, for example, via ingress ports such as the ingress ports 250 and 350 and the ports 420. As shown in the scenario 500, the network switch 510 forwards packets received from the source A, B, and C 520 via the link 532, for example, via an egress port such as the egress ports 260 and 360 and the ports 420. For example, a traffic burst 540 occurs at the link 532 at time T1 causing congestion over the link 532 at time T2, which may trigger explicit or implicit notifications toward the sources 520 to slow down or stop the traffic, where the notifications may be indicated through various mechanisms such as explicit congestion notification (ECN) or traffic discard and retransmission timeout mechanisms. It should be noted that the network switch 510 does not utilize the links 531 and 533 when the link 532 is congested since the ECMP algorithm is load agnostic.

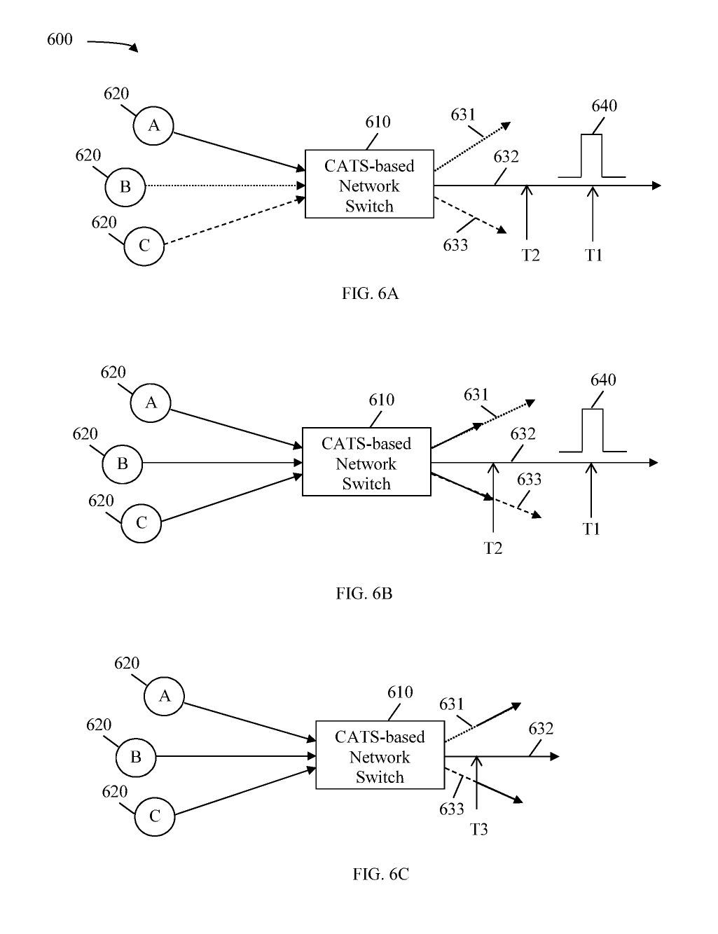

FIGS. 6A-C illustrates various congestion scenarios 600 at a CATS-based network switch 610 operating in a multipath network, such as the network 130. The network switch 610 is similar to the network switch 300 and may employ similar traffic load-aware path and/or port selection mechanisms as the network switch 300. For example, the network may be configured with a plurality of redundant links 631, 632, and 633. A control plane of the network may create a plurality of non-equal cost multipaths (NCMP) based on the redundant links 631, 632, and 633, which may be employed for packet forwarding. FIG. 6A illustrates an embodiment of a congestion detection scenario at the CATS-based network switch 610. As shown, the network switch 610 forwards packets received from a source A 620 over the link 631 (shown by solid arrows), from a source B 620 over the link 632 (shown by dotted arrows), and from a source C 620 over the link 633 (shown by dashed arrows). For example, a traffic burst 640 occurs at the link 632 at time T1. The network switch 610 may employ a traffic manager, such as the traffic manager 320, to monitor utilization levels of transmission queues associated with egress ports, such as the egress ports 260 and 360, that are coupled to the links 631-633. By monitoring transmission queue utilizations, the network switch 610 may detect the occurrence of the traffic burst 640 at time T2.

FIG. 6B illustrates an embodiment of a congestion isolation and traffic diversion scenario at the CATS-based network switch 610. As shown, upon detection of the traffic burst 640, the network switch 610 redirects and/or distributes subsequent traffic received from the source B 620 over the non-congested links 631 and 633, for example, by considering traffic load during path selection, as discussed more fully below.

FIG. 6C illustrates an embodiment of a congestion clear scenario at a CATS-based network switch 610. For example, after some time, at time T3, the congested link 632 is free of congestion, thus the network switch 610 may resume traffic on the link 632. As shown, packets received from the source B 620 are redirected back to the link 632.

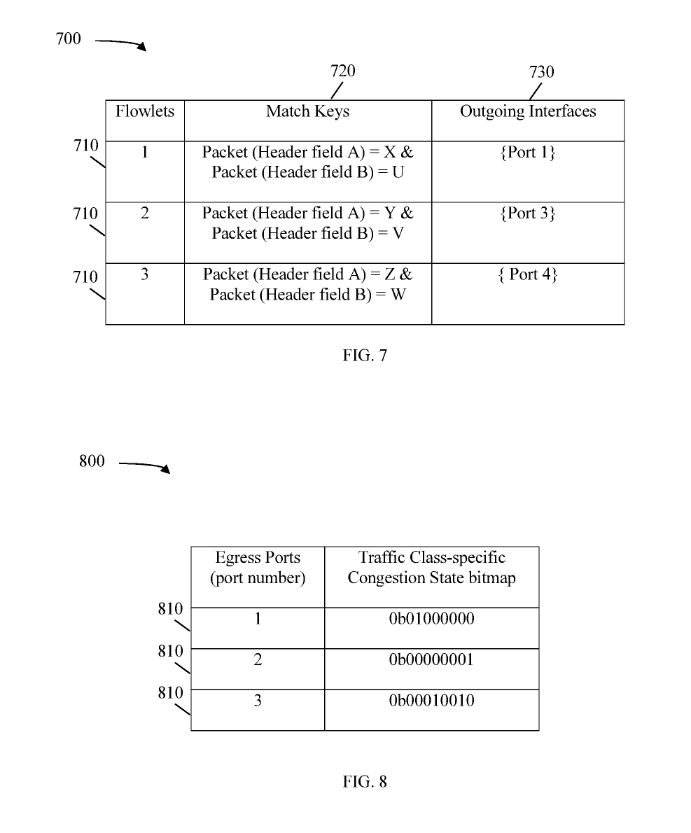

FIG. 7 is a schematic diagram of a flowlet table 700. The flowlet table 700 is employed by a CATS-based network switch, such as the network switches 300 and 610, in a multipath network, such as the network 130. The flowlet table 700 is similar to the flowlet table 315. The flowlet table 700 comprises a plurality of entries 710, each associated with a flowlet in the network. Each entry 710 comprises a match key 720 and an outgoing interface 730. The match key 720 comprises a plurality of match rules for identifying a particular flowlet. As shown, the match rules operate on packet header fields. For example, the network switch comprises a plurality of candidate egress ports, such as the egress ports 260 and 360, each coupled to one of multiple network paths that may be employed for transmitting traffic of the particular flowlet. The outgoing interface 730 identifies an egress port among the candidate egress ports for transmitting the particular flowlet traffic along a corresponding network path. As shown, each flowlet may be forwarded to one egress port coupled to one of the multiple paths in the multipath network.

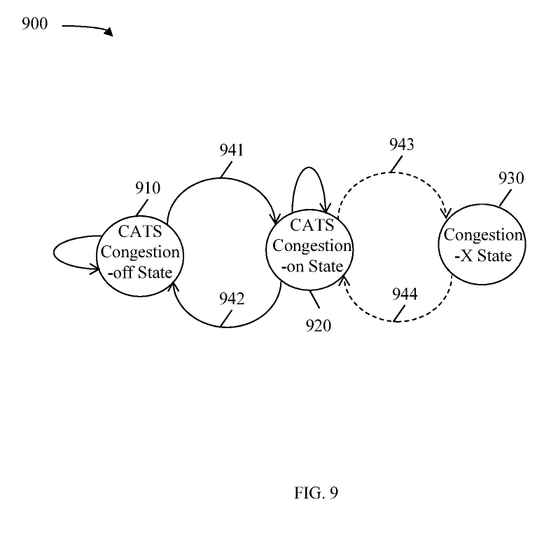

FIG. 8 is a schematic diagram of a port queue congestion table 800. The port queue congestion table 800 is employed by a CATS-based network switch, such as the network switches 300 and 610, in a multipath network, such as the network 130. The port queue congestion table 800 is similar to the port queue congestion table 316. The port queue congestion table 800 comprises a plurality of entries 810, each associated with an egress port, such as the egress ports 260 and 360, of the network switch. Each entry 810 comprises a bitmap (e.g., 8 bits in length), where each bit indicates a congestion state for a particular traffic class. As shown, a particular port may be congested for certain traffic classes, but may be non-congested for some other traffic classes since packets of different traffic classes are enqueued into different transmission queues. In addition, traffic of different traffic classes may require different QoS.

FIG. 9 is a schematic diagram of an egress queue state machine 900. The state machine 900 is employed by a CATS-based network switch, such as the network switches 300 and 610, in a multipath network, such as the network 130. The state machine 900 comprises a CATS congestion-off state 910, a CATS congestion-on state 920, and a congestion-X state 930. The state machine 900 may be applied to any egress port, such as the egress ports 260 and 360, of the network switch. The state machine 900 begins at the CATS congestion-off state 910. For example, the network switch comprises a traffic manager, such as the traffic manager 320, and a packet processor, such as the packet processor 310. The traffic manager monitors usages of an egress queue corresponding to an egress port over the duration of operation (e.g., powered on and active). When the egress queue usage (e.g., utilization level) reaches a CATS congestion-on threshold, the state machine 900 transition from the CATS congestion-off state 910 to the CATS congestion-on state 920 (shown by a solid arrow 941). Upon detection of the state transition to the CATS congestion-on state 920, the traffic manager notifies the packet processor so that the packet processor may stop assigning traffic to the egress port.

When the state machine 900 is operating in the CATS congestion-on state 920, the traffic manager continues to monitor the egress queue usage. When the egress queue usage falls below a CATS congestion-off threshold, the state machine 900 returns to the CATS congestion-off state 910 (shown by a solid arrow 942), where the CATS congestion-on threshold is greater than the CATS-congestion-off threshold. Upon detection of the state transition to the CATS congestion-on state 920, the traffic manager notifies the packet processor so that the packet processor may resume assignment of the traffic to the particular egress port.

The network switch 900 may optionally employ the disclosed CATS mechanisms in conjunction with other congestion control algorithms, such as the ECN and PFCC. For example, the traffic manager may configure an additional threshold for entering the congestion-X state 930 for performing other congestion controls, where the additional threshold is greater than the CATS congestion-on threshold. When operating in the CATS congestion-on state 920, the traffic manager may continue to monitor the egress queue usage. When the egress queue usage reaches the additional threshold, the state machine 900 transitions to the congestion-X state 930 (shown by a dashed arrow 943). Similarly, upon detection of the state transition to the congestion-X state 930, the traffic manager notifies the packet processor and the packet processor may perform additional congestion controls, such as ECN, PFCC, TD, RED, and/or WRED. The state machine 900 may return to the CATS congestion-on state 920 (shown by a dashed arrow 944) when the egress queue usage falls below the additional threshold. It should be noted that the state machine 900 may be applied to track congestion state transition for a particular traffic class for a particular egress port.

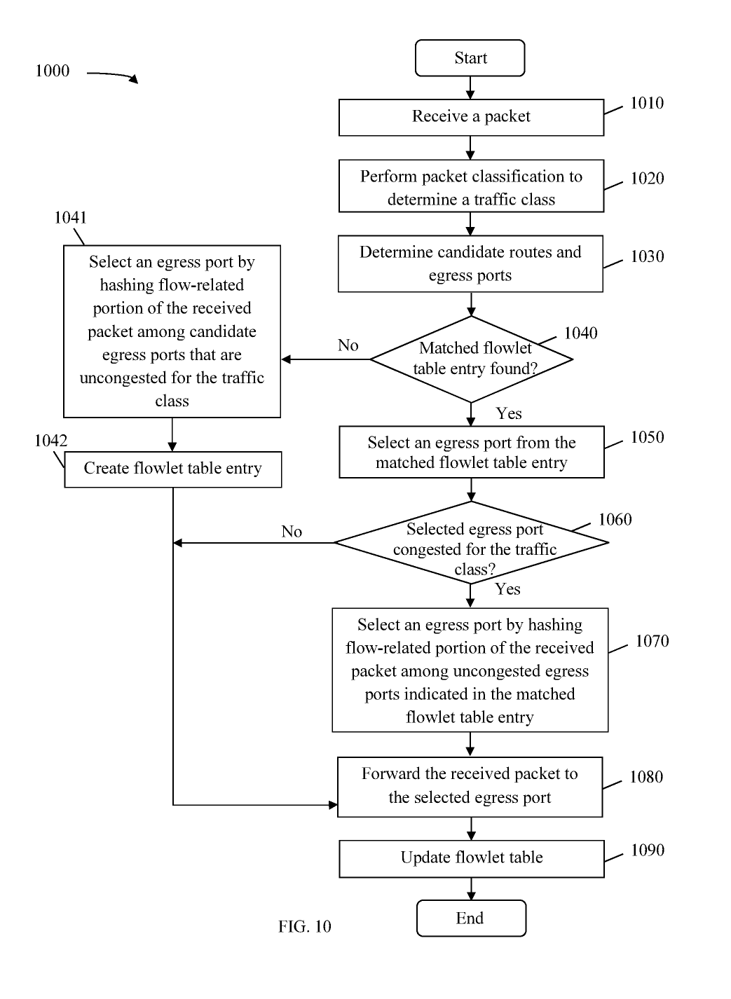

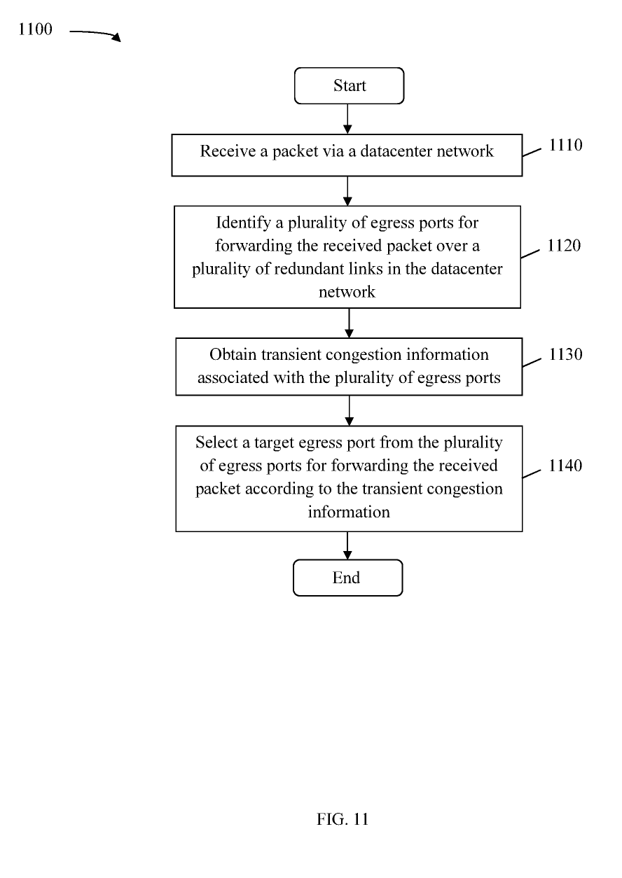

FIG. 10 is a flowchart of an embodiment of a CATS method 1000. The method 1000 is implemented by a network switch, such as the network switch 300 and 610 and the NEs 110 and 400, or specifically by a packet processor, such as the packet processor 310, in the network switch. The method 1000 is implemented when the network switch performs packet switching in a multipath network, such as the network 130, which may be a datacenter network. The method 1000 may employ similar mechanisms as the network switch 300 described above. The network switch may comprise a plurality of ingress ports, such as the ingress ports 250 and 350, and a plurality of egress ports, such as the egress ports 260 and 360. The ingress ports and/or the egress ports may be coupled to redundant links in the multipath network. The network switch may maintain a flowlet table, such as the flowlet tables 315 and 700, and a port queue congestion table, such as the port queue congestion tables 316 and 800. At step 1010, a packet is received, for example, via an ingress port of the network switch from an upstream NE of the network switch. At step 1020, packet classification is performed on the received packet to determine a traffic class, for example, according to the received packet header fields. At step 1030, routes and egress ports for forwarding the received packet are determined, according to the received packet header fields and/or the determined traffic class. In the multipath network, there may be multiple routes for forwarding the received packet towards a destination of the received packet, where each route is coupled to one of the egress ports of the network switch.

At step 1040, a determination is made whether a flowlet table entry, such as the flowlet table entries 710, matches the received packet. For example, a match may be determined by comparing a flowlet-related portion (e.g., packet header fields) of the received packet to a match keys, such as the match key 720, in the entries of the flowlet table. If a match is found, next at step 1050, an egress port is selected from the matched flowlet table entry, where the matched flowlet table entry comprises an outgoing interface, such as the outgoing interface 730, indicating a list of one or more egress ports. For example, the egress port may be selected by hashing the flowlet-related portion of the receive packet among the list of egress ports indicated in the matched flowlet table entry. At step 1060, a determination is made whether the selected egress port is congested for carrying traffic of the determined traffic class, for example, by looking up the port queue congestion table. If the selected egress port is congested for carrying traffic of the determined traffic class, next at step 1070, an egress port is selected by hashing the flow-related portion of the received packet among the uncongested egress ports indicated in the matched flowlet table entry. At step 1080, the received packet is forwarded to the selected egress port. At step 1090, the flowlet table is updated, for example, by refreshing the flowlet entry corresponding to the forwarded packet.

If the selected egress port is determined to be not congested for carrying traffic of the determined traffic class at step 1060, the method 1000 proceeds to step 1080, where the received packet is forwarded to the egress port selected from the matched flowlet table entry at step 1050.

If a match is not found at step 1040, the method 1000 proceeds to step 1041. At step 1041, an egress port is selected by hashing the flow-related portion of the received packet among the candidate egress ports that are uncongested for carrying traffic of the determined traffic class, where the congestion states of the egress ports may be obtained from the port queue congestion table. At step 1042, a flowlet table entry is created. For example, the match key of the created flowlet table entry may comprise rules for matching the flowlet-related portion of the received packet. The outgoing interface of the created flowlet table entry may indicate the egress port selected at step 1041.

It should be noted that although the congested egress ports are excluded from selection (e.g., at steps 1041 and 1070), there may be inflight packets that are previously assigned to the congested egress ports, where the inflight packets may be drained (e.g., transmitted out of the congested egress ports) after some duration. After the inflight packets are drained, the congested egress ports may be free of congestion, where the congestion response and congestion resolve time are discussed more fully below. It should be noted that the method 1000 may be performed in the order as shown or alternatively configured as determined by a person of ordinary skill in the art to achieve similar functionalities.

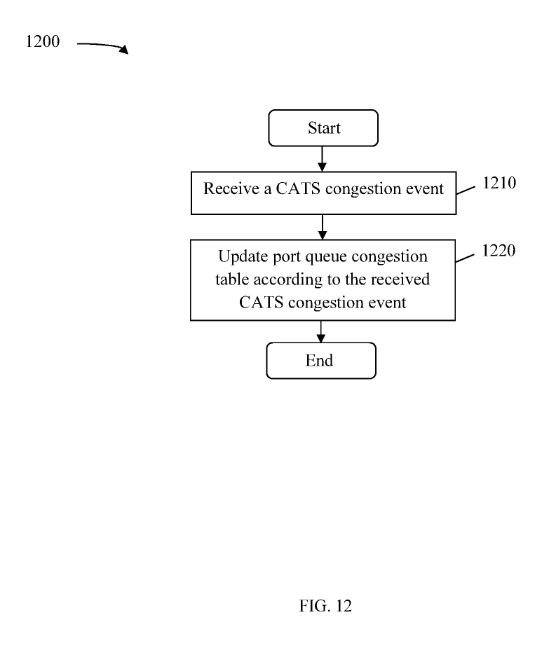

FIG. 11 is a flowchart of another embodiment of a CATS method 1100. The method 1100 is implemented by a network switch, such as the network switch 300 and 610 and the NEs 110 and 400, or specifically by a packet processor, such as the packet processor 310, in the network switch. The method 1100 is similar to the method 1000 and may employ similar mechanisms as the network switch 300 described above. The network switch may comprise a plurality of ingress ports, such as the ingress ports 250 and 350, and a plurality of egress ports, such as the egress ports 260 and 360. The ingress ports and/or the egress ports may be coupled to redundant links in the multipath network. The network switch may maintain a flowlet table, such as the flowlet tables 315 and 700, and a port queue congestion table, such as the port queue congestion tables 316 and 800. The method 1100 begins at step 1110 when a packet is received via a datacenter network. For example, the datacenter network supports multipath for routing packets through the datacenter network. At step 1120, a plurality of egress ports is identified for forwarding the received packet over a plurality of redundant links in the datacenter network. For example, the plurality of egress ports is identified by looking up the flowlet table for an entry that matches the received packet (e.g., packet header fields). At step 1130, transient congestion information associated with the plurality of egress ports is obtained, for example, from the port queue congestion table. The port queue congestion table comprises congestion states of the egress ports, where the congestion states track the congestion-on and congestion-off notifications indicated by a traffic manager, such as the traffic manager 320, as described above. A time interval between the congestion-on notification and the congestion-off notification may be short, for example, less than a few microseconds (μs), and thus the congestion is transient. At step 1140, a target egress port is selected from the plurality of egress ports for forwarding the packet according to the dynamic traffic load information. For example, when the dynamic traffic load information indicates that one of the egress ports is congested, the selection of the target egress port may exclude the congested egress port from selection. Subsequently, when the congested egress port recovers from congestion, subsequent packets may be assigned to the egress port for transmission.

FIG. 12 is a flowchart of an embodiment of a CATS congestion event handling method 1200. The method 1200 is implemented by a network switch, such as the network switch 300 and 610 and the NEs 110 and 400, or specifically by a packet processor, such as the packet processor 310, in the network switch. The method 1200 may employ similar mechanisms as the network switch 300 described above. The network switch may comprise a plurality of ingress ports, such as the ingress ports 250 and 350, and a plurality of egress ports, such as the egress ports 260 and 360. The method 1200 begins at step 1210 when a CATS congestion event is received, for example, from a traffic manager, such as the traffic manager 320. The CATS congestion event may indicate an egress port congestion state transition. For example, the CATS congestion event may be a CATS congestion-on notification indicating the egress port transitions from an uncongested state to a congested state. The congestion may be caused by traffic bursts. The CATS congestion-on notification may further indicate that the congestion is for carrying traffic of a particular traffic class. As described above, the traffic manager may employ different thresholds for different traffic classes. Conversely, the CATS congestion event may be a CATS congestion-on notification indicating the egress port returns to the uncongested state from the congested state. Similar to the CATS congestion-on notification, the CATS congestion-off notification may further indicate that the congestion is cleared for carrying traffic of a particular traffic class. At step 1220, the port queue congestion table is updated according to the received CATS congestion event. For example, the port queue congestion table may comprise entries similar to the entries 810, where each entry comprises a bitmap indicating traffic class-specific congestion states for an egress port.

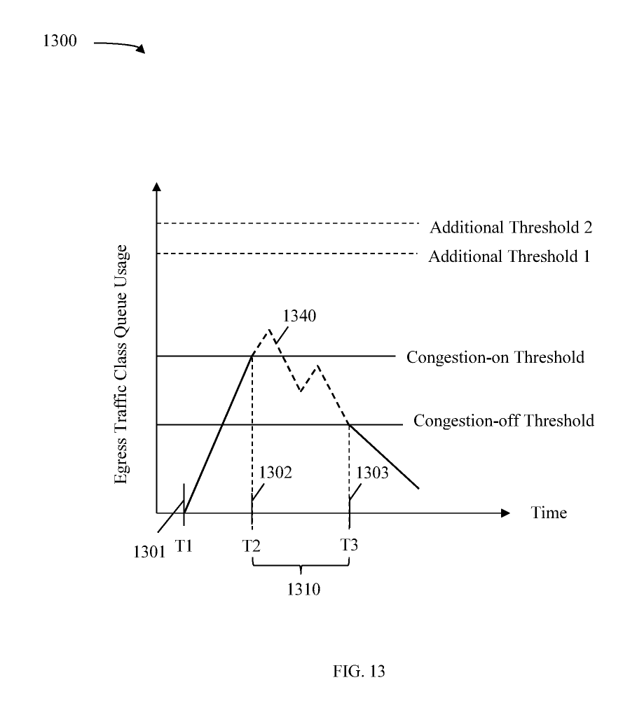

FIG. 13 is a graph 1300 illustrating an example egress traffic class queue usage over time for a network switch, such as the network switches 300 and 610. The network switch may employ a state machine similar to the state machine 900 to determine congestion states. In the graph 1300, the x-axis represents time in some arbitrary units and the y-axis represents usages of an egress queue, for example, in units of number of packets. The curve 1340 represents the usages of an egress queue employed for queueing packets for transmission over an egress port, such as the egress ports 260 and 360, of the network switch. As shown, the network switch begins to queue packets in the egress queue at time T1 (shown as 1301). For example, the network switch is operating in a CATS congestion-off state, such as the CATS congestion-off state 910. At time T2 (shown as 1302), the egress queue usage reaches a CATS congestion-on threshold, where the network switch may transition to a CATS congestion-on state, such as the CATS congestion-on state 920. At time T3 (shown as 1303), the egress queue usage falls to a CATS congestion-off threshold, where the network switch may return to the CATS congestion-off state. Thus, the solid portions of the curve 1340 correspond to non-congested traffic and the dashed portions of the curve 1340 correspond to congested traffic.

As shown in graph 1300, the network switch may employ an additional threshold 1 and an additional threshold 2 to perform further congestion controls. For example, when the egress queue usage reaches the additional threshold 1, the network switch may start to execute ECN or PFCC congestion controls to notify upstream hops. When the egress queue usage continues to increase to the additional threshold 2, the network switch may start to drop packets, for example, by employing a TD or a RED control method. It should be noted that the egress queue usage may fluctuate depending on the ingress traffic, for example, as shown in the duration 1310 between time T2 and time T3.

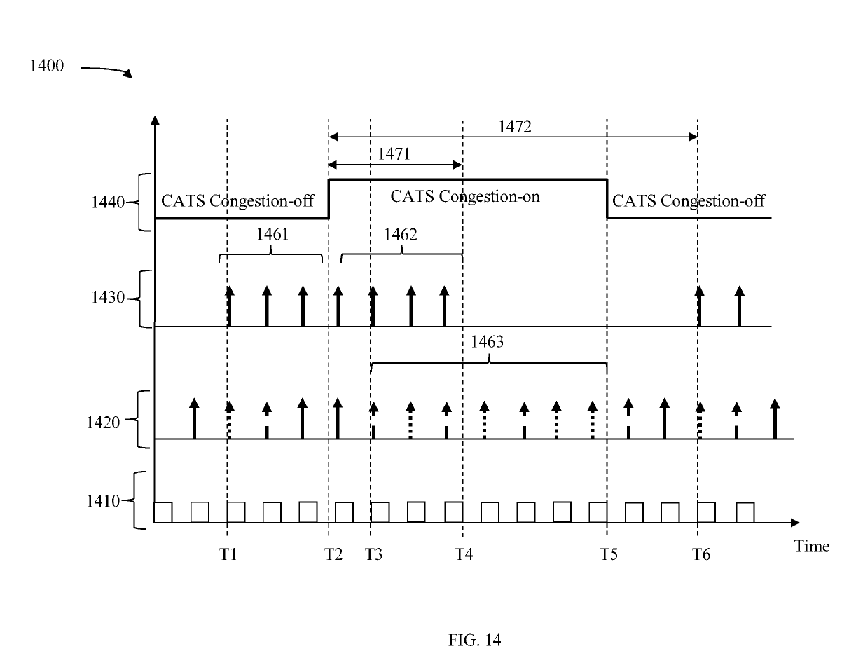

FIG. 14 is a timing diagram illustrating an embodiment of a CATS congestion handling scenario 1400 at a CATS-based network switch, such as the network switch 300 and 610, operating in a multipath network, such as the network 130. For example, the scenario 1400 may be captured when the network switch employs the methods 1000, 1100, and/or 1200 and/or the state machine 900 for CATS. The x-axis represents time in some arbitrary timing units. The y-axis represents activities at the network switch. For example, the network switch may comprise a plurality of egress ports, such as the egress ports 260 and 360. The scenario 1400 shows packet queuing activities and congestion state transitions in relation to egress port selection during congestion. As shown, the activity graph 1410 corresponds to a clock signal at the network switch. The activity graph 1420 corresponds to port assignments resolved by a port resolver, such as the path selector 313. The activity graph 1430 corresponds to packet queueing at an egress queue (e.g., an egress queue X) corresponding to a particular egress port X at the network switch. The activity graph 1440 corresponds to CATS state transition for the particular egress port. For example, the network switch may be designed to enqueue a packet per clock signal and to resolve or assign an egress port for transmitting a packet per clock signal.

As shown in the activity graph 1420, the port resolver assigns and/or enqueues packets into three egress queues, each corresponding to one of the egress ports at the network switch. For example, the port resolver may have similar mechanisms as the path selector 313 and the methods 1000, 1100, and 1200. For example, the solid arrows represent packets assigned to egress port X and/or enqueue into the egress queue X. The dotted arrows represent packets assigned to an egress port Y and/or enqueue into an egress queue Y. The dashed arrows represent packets assigned to an egress port Z and/or enqueue into an egress queue Z.

In the scenario 1400, the CATS state for the egress queue X begins with a CATS congestion-off state. At time T1, the activity graph 1430 shows a burst of packets 1461 are enqueued for transmission via the particular egress port X. At time T2, the activity graph 1440 shows that the network switch detects the burst of packets 1461 at the egress queue X, for example, via a traffic manager, such as the traffic manager 320, based on a CATS congestion-on threshold. When the usage of the egress queue X reaches the CATS congestion-on threshold, the traffic manager transitions the CATS state to a CATS congestion-on state and notifies the port resolver. However, the packets (e.g., in-flight packets 1462) that are already in the pipeline for transmission over the egress port X may continue for a duration, for example, until time T4. At time T3, the activity graph 1420 shows that the port resolver stopped assigning packets to the egress queue X (e.g., no solid arrows over the duration 1463). At time T4, the in-flight packets 1462 in the egress queue X are drained and no new packets are enqueued into the egress queue X. The time duration between the time (e.g., time T2) when a traffic burst is detected to the time when packets are drained at the egress queue X (e.g., time T4) is referred to as the congestion response time 1471.

At time T5, the activity graph 1440 shows that the traffic manager detects that the egress port X is free of congestion, and thus switches the CATS state to a CATS congestion-off state and notifies the port resolver. Subsequently, the activity graph 1420 shows that the port resolver resume packet queuing at the egress queue X, in which packets are enqueued into the egress queue X at time T6 after congestion is resolved. The time duration between the time (e.g., time T2) when a traffic burst is detected to the time when packet enqueuing to the egress queue X is resumed (e.g., time T6) is referred to as the congestion resolve time 1472. It should be noted that the congestion response time 1471 and the congestion resolve time 1472 shown in the scenario 1400 is for illustrative purpose. The number of clocks or the duration of the congestion response time and the congestion resolve time may vary depending on various design and operational factors, such as transmission schedules, queue lengths, and the pipelining architecture of the network switch. However, for bursty traffic, the congestion response time 1471 may be about a few dozen of nanoseconds (ns) and the congestion resolve time 1472 may be within about one scheduling cycle (e.g., about 0.5 μs to about 1 μs).

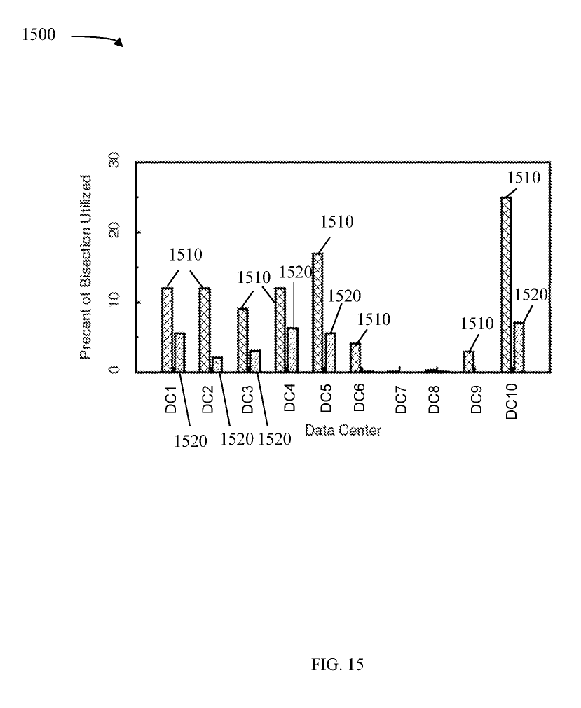

FIG. 15 is a graph 1500 of example datacenter bisection bandwidth utilization. In the graph 1500, the x-axis represents ten different datacenters (e.g., DC1, DC2, DC3, DC4, DC5, DC6, DC7, DC8, DC9, DC10) and the y-axis represents datacenter bisection bandwidth utilization in units of percentages. The bars 1510 correspond to the ratio of aggregate server traffic over bisection bandwidth at the datacenters and the bars 1520 correspond to the ratio of aggregate server traffic over full bisection capacity at the datacenters, where the datacenters may comprise networks similar to the network 130. The bisection bandwidth refers to the bandwidth across a smallest cut that divides a network (e.g., the number of nodes, such as the NEs 110, and the number of links, such as the links 131) into two equal halves. The full bisection capacity refers to the capacity required for supporting servers communicating at full speeds with arbitrary traffic matrices and no oversubscription. As shown, the utilizations across the datacenters are below 30%.

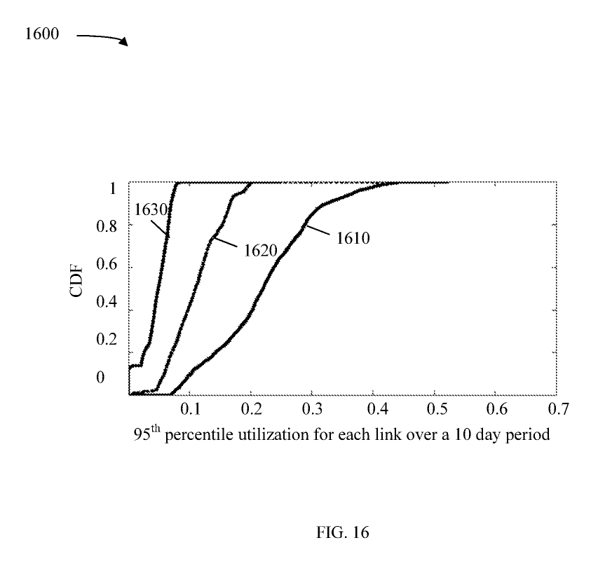

FIG. 16 is a graph 1600 of example datacenter link utilization CDF. In the graph 1600, the x-axis represents 95^{th} percentile link utilization over a ten day period and the y-axis represents CDF. The curve 1610 corresponds to a CDF measured from nineteen datacenters core layer links, where the datacenters may comprise networks similar to the network 130. The curve 1620 corresponds to a CDF measured from aggregation layer links of the datacenters. The curve 1630 corresponds to a CDF measured from edge layer links of the datacenters. As shown, the link utilization at the core layer is significantly higher than the aggregation layer and the edge layer, where the average core layer link utilization is about 20% and the maximum core layer link utilization is below about 50%. Thus, congestion is more likely to occur at the core layer.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed:

1. A network element (NE) comprising:
an ingress port configured to receive a first packet via a multipath network;
a plurality of egress ports configured to couple to a plurality of links in the multipath network; and
a processor coupled to the ingress port and the plurality of egress ports, wherein the processor is configured to:
determine that the plurality of egress ports are candidate egress ports for forwarding the first packet;
obtain dynamic traffic load information associated with the candidate egress ports; and
select a first target egress port from the candidate egress ports for forwarding the first packet according to the dynamic traffic load information.

2. The NE of claim 1, wherein the dynamic traffic load information indicates that one of the candidate egress ports is in a congested state, and wherein the processor is further configured to select the first target egress port for forwarding the first packet by excluding the congested candidate egress port from selection.

3. The NE of claim 2, wherein the processor is further configured to exclude the congested candidate egress port from selection by applying a hash function to a flow-related portion of the first packet based on remaining uncongested egress ports.

4. The NE of claim 1, wherein the dynamic traffic load information indicates that a first of the candidate egress ports is in a congested state for carrying traffic of a particular traffic class, and wherein the processor is further configured to:
perform packet classification on the first packet to determine a first traffic class for the first packet;
determine whether the first traffic class corresponds to the particular traffic class; and
select the first target egress port for forwarding the first packet by excluding the first candidate egress port when determining that the first traffic class corresponds to the particular traffic class.

5. The NE of claim 1, further comprising a memory configured to store a port queue congestion table comprising a plurality of congestion states of the plurality of egress ports, wherein the processor is further configured to:
receive a congestion-on notification indicating a first of the candidate egress ports transitions from an uncongested state to a congested state; and
update a congestion state of the first candidate egress port in the port queue congestion table to the congested state in response to receiving the congestion-on notification, and
wherein the dynamic traffic load information is obtained from the port queue congestion table stored in the memory.

6. The NE of claim 5, wherein the processor is further configured to:
receive a congestion-off notification indicating the first candidate egress port returns to the uncongested state from the congested state; and
update the congestion state of the first candidate egress port in the port queue congestion table to the uncongested state in response to receiving the congestion-off notification.

7. The NE of claim 6, wherein the processor is further configured to select the first target egress port for forwarding the first packet by including the first candidate egress port for selection when the first candidate egress port returned to the uncongested state during the selection.

8. The NE of claim 6, wherein the first egress port transitioned to the congested state at a first time instant, wherein the first egress port returned to the uncongested state at a second time instant, and wherein a time interval between the first time instant and the second time instant is in an order of microseconds.

9. The NE of claim 1, further comprising a memory configured to store a flowlet table comprising a plurality of entries, wherein each entry comprises a match key that identifies a flowlet in the multipath network and a corresponding outgoing interface, wherein the processor is further configured to identify the first target egress port for forwarding the first packet by determining that the first packet matches the match key in a flowlet table entry, and wherein an outgoing interface corresponding to the matched entry the first target egress port.

10. The NE of claim 9, wherein the ingress port is further configured to receive a second packet, wherein the dynamic traffic load information indicates that one of the plurality of egress ports is congested, and wherein the processor is further configured to:
search for an entry that matches the second packet from the flowlet table;
determine that a matched entry is not found in the flowlet table; and
select a second target egress port for forwarding the second packet by applying a hash function to a portion of the second packet based on remaining uncongested egress ports, wherein the portion of the second packet defines an additional flowlet in the multipath network.

11. A network element (NE), comprising:
an ingress port configured to receive a plurality of packets via a multipath network;
a plurality of egress ports configured to forward the plurality of packets over a plurality of links in the multipath network;
a memory coupled to the ingress port and the plurality of egress ports, wherein the memory is configured to store a plurality of egress queues, and wherein a first of the plurality of egress queues stores packets awaiting transmissions over a first of the plurality of links coupled to a first of the plurality of egress ports; and
a processor coupled to the memory and configured to send a congestion-on notification to a path selection element when determining that a utilization level of the first egress queue is greater than a congestion-on threshold,
wherein the congestion-on notification instructs the path selection element to stop selecting the first egress port for forwarding first subsequent packets.

12. The NE of claim 11, wherein the congestion-on threshold is associated with a particular traffic class, and wherein the congestion-on notification further instructs the path selection element to stop selecting the first egress port for forwarding second subsequent packets of the particular traffic class.

13. The NE of claim 11, wherein the processor is further configured to send a congestion-off notification to the path selection element when determining that the utilization level of the first egress queue is less than a congestion-off threshold, wherein the congestion-off notification instructs the path selection element to resume selection of the first egress port for forwarding third subsequent packets, and wherein the congestion-off threshold is less than the congestion-on threshold.

14. The NE of claim 12, wherein the congestion-off threshold is for a particular traffic class, and wherein the congestion-off notification further instructs the path selection element to resume the selection of the first egress port for forwarding fourth subsequent packets of the particular traffic class.

15. The NE of claim 11, wherein the processor is further configured to send an additional notification to the path selection element when determining that the utilization level of the first egress queue is greater than an additional threshold, wherein the additional notification instructs the path selection element to perform additional congestion controls, and wherein the additional threshold is greater than the congestion-on threshold.

16. A method implemented in a network element (NE), the method comprising:
receiving a packet via a datacenter network;
identifying a plurality of NE egress ports for forwarding the received packet over a plurality of redundant links in the datacenter network;
obtaining transient congestion information associated with the plurality of NE egress ports; and
selecting a target NE egress port from the plurality of NE egress ports for forwarding the received packet according to the transient congestion information.

17. The method of claim 16, wherein the transient congestion information indicates that one of the plurality of NE egress ports transitions to a congested state, and wherein selecting the first target NE egress port for forwarding the first packet comprises excluding the congested NE egress port from selection.

18. The method of claim 17, wherein excluding the congested NE egress port from selection comprises applying a hash function to a flow-related portion of the first packet based on remaining uncongested NE egress ports.

19. The method of claim 16, wherein the transient congestion information indicates that a first of the plurality of NE egress ports transitions to a congested state for carrying traffic of a particular traffic class, wherein the method further comprises:
performing packet classification on the first packet to determine a first traffic class for the first packet; and
determining whether the first traffic class corresponds to the particular traffic class, and
wherein selecting the first target NE egress port for forwarding the first packet comprises excluding the first NE egress port when determining that the first traffic class corresponds to the particular traffic class.

20. The method of claim 16, further comprising enqueueing the packet at a first of a plurality of egress queues prior to transmission to the selected target NE egress port, wherein obtaining the transient congestion information comprises tracking utilization levels of the plurality of egress queues.
